(19) United States
(12) Patent Application Publication
(10) Pub. No.: US 2001/0025257 A1
(43) Pub. Date: Sep. 27, 2001

(54) Method of transacting merchandise on on-line shopping and system of processing information about intermediary

(76) Inventor: Ryuji Sato, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/778,863

(22) Filed: Feb. 8, 2001

(30) Foreign Application Priority Data
Feb. 8, 2000 (JP) 2000-029876

(51) Int. Cl. G06F 17/60

(52) U.S. Cl. 705/26

(57) ABSTRACT

In the packet transmission step 102, a user transmits the packet regarding the order of a commodity to an intermediary in the user merchandise ordering step 101. In the intermediary merchandise ordering step 103, the intermediary orders the commodity to the electronic mall keeper by specifying itself as a merchandise shipping destination. In the credit card number notification step 104, the intermediary notifies the electronic mall keeper of its credit card number. In the secret decryption key transmission step 107, the user transmits the secret decryption key for the packet to the intermediary, in exchange of the commodity received in the intermediary merchandise shipping step 106. In the cash and commission receiving step 108, the intermediary deciphers the cipher of the packet with the secret decryption key to obtain the credit card number.

### BACKGROUND OF THE INVENTION

The present invention relates to a method of transacting merchandise on an on-line shopping in a computer system realizing on-line. The transacting method is executed by using an intermediary between an electronic mall keeper and users (or using a third party which intermediates between an electronic mall keeper and users). The electronic mall keeper means a trader involved in sales on-line shopping in an electronic mall (where a shopping district or department store being a collection of shops or distributors is electrically realized).

Moreover, the present invention relates to an intermediary information processing system being an information processing system realizing the above-mentioned intermediary.

In a conventional merchandise transaction method on on-line shopping, a user notifies an electronic mall keeper of names of commodities to be purchased and the user's credit card number via a network and waits for the arrival of them.

FIG. 10 is a flow chart illustrating a process procedure of the conventional merchandise transaction method mentioned above.

FIG. 11 is a block diagram illustrating the configuration of an on-line shopping system for realizing the conventional merchandise transaction method. In the on-line shopping system, the terminal (information processing terminal) exchanges orders (transactions) between the user and the electronic mall keeper via a network, as shown in FIG. 11.

FIG. 12 a block diagram explaining the operation of the conventional merchandize transaction method mentioned above.

The procedure (aspect) of merchandise transaction in the conventional merchandise transaction method on on-line shopping will be explained with reference to FIGS. 10 to 12. That is, the conventional merchandise transaction method on on-line shopping uses terminals and networks and implements the following process (a to c). Symbols a, b and c in FIG. 12 correspond to symbols a, b and c in the following description, respectively.

(a) A user orders desired items to a specific electronic mall keeper (step 1001 in FIG. 10).

(b) The user notifies the electronic mall keeper of the credit card number thereof, using an information transfer device such as terminal (information processing terminal), FAX (facsimile machine), or the like shown in FIG. 11 (step 1002).

(c) The electronic mall keeper ships the items to the user (step 1003). This shipment is performed by means of transportation, not the network 5.

However, the above-mentioned merchandise transaction method has the following disadvantages.

The credit card number of a user may be used through an illegal act of an electronic mall keeper (First problem). This occurs because the credit card number of a user is sent to a dishonest electronic mall keeper.

Moreover, every time a user purchases items, the user has to check the credibility of each electronic mall keeper. The reason why such a problem exists is that the user has to bargain (deal) with to an indefinite number of electronic mall keepers to purchase a variety of items.

There is the collect-on-delivery method in which a user remits the money to the electronic mall keeper after confirmation of the arrival of an item. However, where this method is adopted to avoid the above-mentioned first problem, the problem may occur that the user may delay the remittance or may not remit the money after the receiving of an item (that is, a user's dishonest act in which the electronic mall keeper is involved may occur).

### SUMMARY OF THE INVENTION

The present invention is made to overcome the above-mentioned problems. An objective of the present invention is to provide a merchandise transaction method on on-line shopping and thus can realize an on-line shopping system that can improve the credibility of transactions between users and electronic mall keepers. This method sets a third party (an intermediary) going between an electronic mall keeper and users and utilizes a transaction procedure using a credit-card-number-enciphered packet (hereinafter referred to as “packet”) and a secret decryption key for deciphering the packet. The user can do on-line shopping, without directly bargaining with an unspecified number of electronic mall keepers, thus being able to avoid the risk of indicating the credit card number to an electronic mall keeper or the difficulty of checking the credibility of a large number of electronic mall keepers. On the other hand, the electronic mall keeper can avoid the risk of a delayed remittance or no payment by a user.

Moreover, another objective of the present invention is to provide a merchandise transaction method on on-line shopping that prepares the flow of two transactions including the first transaction and the second or later transaction between a user and an intermediary. Thus, the reliability in transaction between a user and an intermediary and simplification of the transaction procedure (shortage of an order process) can be improved.

Moreover, a further another objective of the present invention is to provide an intermediary information processing system being an information processing system that can realize the above-mentioned merchandise transaction method on on-line shopping.

According to the present invention, a merchandise transaction method in an on-line shopping system, comprises a user merchandise ordering step in which a user orders commodities by transmitting information about a desired electronic mall keeper and information about commodities to be purchased to an intermediary; a packet transmission step in which the user transmits a packet regarding the merchandise order in the previous step to the intermediary; an intermediary merchandise ordering step in which the intermediary orders commodities by specifying itself as a merchandise shipping destination to the electronic mall keeper, based on the information received in the previous step; a credit card number notification step in which the intermediary notifies the electronic mall keeper of a credit card number of the intermediary; an electronic mall keeper merchandise shipping step in which the electronic mall keeper ships the commodities to the intermediary; an intermediary merchandise shipping step in which the intermediary ships the commodities to the user; a secret decryption key transmission step in which the user transmits a secret decryption key for the packet to the intermediary, in exchange of the commodities received in the previous step; and a cash and commission receiving step in which the intermediary acquires a credit card number by deciphering the previously received packet cipher with the secret decryption key acquired in the precious step and then receives a cash and commission of the commodities with the credit card number.

More generally, a merchandise transaction method on on-line shopping in an on-line shopping system, comprises a first step in which an intermediary receives information about an electronic mall keeper to which a user desires transaction, information about commodities to be purchased by the user, and a packet and executes an order and payment of commodities to an electronic mall keeper in behalf of the user; and a second step in which the intermediary receives a secret decryption key for the packet transmitted from the user in exchange of the commodities and then obtains a credit card number of the user by deciphering the packet cipher.

Moreover, according to the present invention, a merchandise transaction method on on-line shopping in an on-line shopping system, comprises a transaction-count decision step of deciding whether or not a transaction between a user which wants to purchase a commodity and an intermediary is for the first time; a user merchandise ordering step in which the user orders the commodity by transmitting information about an electronic mall keeper desired by the user and information about a commodity to be purchased to the intermediary when it is decided that the transaction between the user and the intermediary is for the first time in the previous step; an intermediary merchandise ordering step in which the intermediary orders the commodity by specifying itself as a merchandise shipping destination to an electronic mall keeper, based on the sets of information received in the previous step; a credit card number notification step in which the intermediary notifies the credit card number of the intermediary to the electronic mall keeper at the first transaction between the user and the intermediary; an electronic mall merchandise shipping step in which the electronic mall keeper ships the commodity to the intermediary at the first step between the user and the intermediary; an intermediary merchandise shipping step in which said intermediary ships said commodity to said user at the first step between said user and said intermediary; a secret decryption key transmission step in which the user transmits the secret decryption key for the packet to the intermediary, in exchange of the commodity received in the previous step; a cash and commission receiving step in which the intermediary acquires the credit card number by deciphering the cipher of the packet received in the previous step with the secret decryption key acquired in the previous step and then receives a cash and commission for the commodity with said credit card number; a credit card number recording step in which the intermediary records corresponding information for the purpose of the second or later transaction to the user, the corresponding information being used to uniquely identify the user with the credit card number of the user obtained in the previous step; a second or later transaction user merchandise ordering step in which the user orders the commodity by transmitting information about a desired electronic mall keeper and information about a desired commodity to the intermediary when it is decided that a transaction between the user and the intermediary is the second time or later in the previous step; a second or later transaction intermediary merchandise ordering step in which the intermediary orders the commodity by specifying the user as a merchandise shipping destination to the electronic mall keeper, based on the information received in the previous step; a second or later transaction credit card number notification step in which the intermediary notifies the credit card number of the intermediary to the electronic mall keeper at the second or later transaction between the user and the intermediary; a second and later transaction electronic mall keeper merchandise shipping step in which the electronic mall keeper ships the commodity to the user at the second or later transaction between the user and the intermediary; a merchandise arrival notification step in which the user, which has received the commodity in the previous step, notifies the intermediary of arrival of the commodity; and a second or later transaction cash and commission receiving step in which the intermediary receives a cash and commission of the commodity with the credit card number of the user recorded in the previous step at the second or later transaction between the user and the intermediary.

More generally, a merchandise transaction method on on-line shopping in an on-line shopping system, comprises, at a first transaction between a user which desires to purchase commodities and an intermediary, a first step in which an intermediary receives information about an electronic mall keeper to which the user desires transaction, information about commodities to be purchased by the user, and a packet and executes an order and payment of commodities to an electronic mall keeper in behalf of the user; a second step in which the intermediary receives a secret decryption key for the packet transmitted from the user in exchange of the commodities and then obtains a credit card number of the user by deciphering the packet cipher; a third step in which the intermediary records a credit card number of the user acquired through decryption of the packet; at the second or later transaction between the user which desires to purchase commodities and the intermediary, a fourth step in which the intermediary receives information about an electronic mall keeper to which the user desires transaction and information about commodities to be purchased by the user and then executes an order and payment of the commodities to an electronic mall keeper in behalf of the user; and a fifth step in which the intermediary acquires a credit card number of the user based on the record in the third step.

According to the present invention, an intermediary information processing system which intermediates between a user and an electronic mall keeper in an on-line shopping system, comprises a merchandise order receiver for receiving an order of a commodity from a user, the commodity order including information about a desired electronic mall keeper and information about a commodity to be purchased; a packet receiver for receiving a packet transmitted by the user in the merchandise order by the merchandise order receiver; a merchandise order transmitter for ordering the commodity by specifying the intermediary as a merchandise shipping destination to the electronic mall keeper, based on information received by the merchandise order receiver; a credit card number notifier for notifying the electronic mall keeper of the credit card number of the intermediary to pay for a merchandise order by the merchandise order transmitter; a merchandize receiver for receiving the commodity shipped by the electronic mall keeper; a merchandize shipper for shipping the commodity received by the merchandise receiver to the user; a secret decryption key receiver for receiving a secret decryption key transmitted from the user, in exchange of reception of the commodity; and a cash/commission receiver for acquiring a credit card number by deciphering the packet cipher with the secret decryption key received by the secret decryption key receiver and then receiving a cash and commission of the commodity with the credit card number.

Moreover, according to the present invention, an intermediary information processing system which intermediates between a user and an electronic mall keeper in an on-line shopping system, comprises a transaction-count decider for deciding whether or not a transaction to a user which wants to purchase a commodity is for the first time; a merchandise order receiver for receiving an order of a commodity from a user, the commodity order including information about a desired electronic mall keeper and information about a commodity to be purchased; a packet receiver for receiving a packet transmitted by the user in the merchandise order by the merchandise order receiver when the transaction-count decider decides that the transaction to the user is for the first time; a merchandize order transmitter for ordering the commodity to the electronic mall keeper, based on information received by the merchandise order receiver, by specifying the intermediary as a merchandise shipping destination when the transaction-count decider decides that the transaction to said user is for the first time or by specifying the user as a merchandise shipping destination when the transaction-count decider decides that the transaction to the user is not for the first time; a credit card number notifier for notifying the electronic mall keeper of the credit card number of the intermediary to pay for a merchandise order by the merchandise order transmitter; a merchandise receiver for receiving the commodity shipped by the electronic mall keeper, with the intermediary as a merchandise shipping destination; a merchandise shipper for shipping the commodity received by the merchandise receiver to the user; a secret decryption key receiver for receiving a secret decryption key transmitted from the user, in exchange of reception of the commodity when the transaction-count decider decides that the transaction to the user is for the first time; an initial cash/commission receiver for acquiring a credit card number by deciphering the packet cipher with the secret decryption key received by the secret decryption key receiver and then receiving a cash and commission of the commodity with the credit card number; a credit card number recorder for recording corresponding information to pay for the second or later transaction to the user when the transaction-count decider decides that the transaction to the user is for the first time, the corresponding information being used to uniquely identify the user with the credit card number of the user acquired by the initial cash/commission receiver; a merchandise arrival notification receiver for receiving notification of arrival of the commodity dispatched from the electronic mall keeper to said user when the transaction count decider decides that the transaction to the user is not for the first time; and a second or later transaction cash/commission receiver for receiving a cash and commission for the commodity with the credit card number of the user recorded by the credit card number recorder when the trade count decider decides that the transaction to the user is not for the first time.

Moreover, the present invention relates to a recording medium on which a control program is stored, wherein the control program controls an information processing system of an intermediary which intermediates between a user and an electronic mall keeper in an on-line shopping system. The control program makes the information processing device execute the following steps of receiving a merchandise order including information about a desired electronic mall keeper and information about an item to be purchased from a user; receiving a packet transmitted from the user in the merchandise order; ordering an item by specifying an intermediary as a merchandise shipping destination to the electronic mall keeper, based on the information about the merchandise order; notifying the electronic mall keeper of a credit card number of the intermediary to pay for the merchandise order; receiving a secret decryption key transmitted from the user, in exchange of the ordered item; and acquiring the credit card number by deciphering the packet cipher with the secret decryption key and then receiving a cash and commission of the item with the credit card number.

Moreover, the present invention relates to a recording medium on which a control program is stored, wherein the control program controls an information processing system of an intermediary which intermediates between a user and an electronic mall keeper in an on-line shopping system. The control program makes the information processing device execute the following steps of deciding whether or not a transaction to a user which wants to purchase an item is for the first time; receiving a merchandise order from a user, the merchandise order including information about a desired electronic mall keeper and information about an item to be purchased; receiving a packet transmitted by the user in the merchandise order when it is decided that the transaction to the user is for the first time; ordering the item to the electronic mall keeper, based on information about the received merchandise order, by specifying the intermediary as a merchandise shipping destination when it is decided that the transaction to the user is for the first time or by specifying the user as a merchandise shipping destination when it is decided that the transaction to the user is not for the first time; notifying the electronic mall keeper of the credit card number of the intermediary to pay for the merchandise order; receiving a secret decryption key transmitted from the user, in exchange of reception of the item when it is decided that the transaction to the user is for the first time; acquiring a credit card number by deciphering the packet cipher with the received secret decryption key and then receiving a cash and commission for the item in the first transaction with the credit card number; recording corresponding information for the second or later transaction to the user when it is decided that the transaction to the user is for the first time, the corresponding information being used to uniquely identify the user with the credit card number of the user acquired in the first transaction; receiving notification of arrival of the item dispatched from the electronic mall keeper to the user when it is decided that the transaction to the user is not for the first time; and receiving a cash and commission for the item with the recorded credit card number of the user when it is decided that the transaction to the user is not for the first time.

### BRIEF DESCRIPTION OF THE DRAWINGS

This and other objects, features and advantages of the present invention will become more apparent upon a reading of the following detailed description and drawings, in which:

FIG. 1 is a flow chart illustrating of the process procedure of a merchandise transaction method on on-line shopping, according to a first embodiment of the present invention;

FIG. 2 is a block diagram illustrating the configuration of an on-line shopping system for realizing a merchandise transaction method on on-line shopping shown in FIGS. 1 and 4;

FIG. 3 is a block diagram illustrating the operation in a merchandise transaction method on on-line shopping shown in FIGS. 1 and 4;

FIG. 4 is a flow chart illustrating the process procedure of a merchandise transaction method on on-line shopping, according to a second embodiment of the present invention;

FIG. 5 is a block diagram illustrating the operation of a merchandise transaction method on on-line shopping shown in FIG. 4;

FIG. 6 is a block diagram illustrating the configuration of an intermediary information processing system according to the third embodiment of the present invention;

FIG. 7 is a block diagram illustrating the configuration of an intermediary information processing system according to the fourth embodiment of the present invention;

FIG. 8 is a block diagram illustrating the configuration of an intermediary information processing system according to the fifth embodiment of the present invention;

FIG. 9 is a block diagram illustrating the configuration of an intermediary information processing system according to the sixth embodiment of the present invention;

FIG. 10 is a flow chart illustrating the process procedure of a conventional merchandise transaction method on on-line shopping;

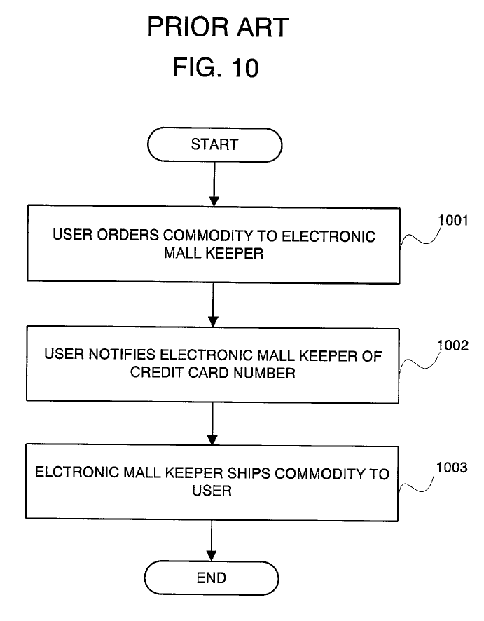

FIG. 11 is a block diagram illustrating the configuration of an on-line shopping system to realize the merchandise transaction method on on-line shopping shown in FIG. 10; and

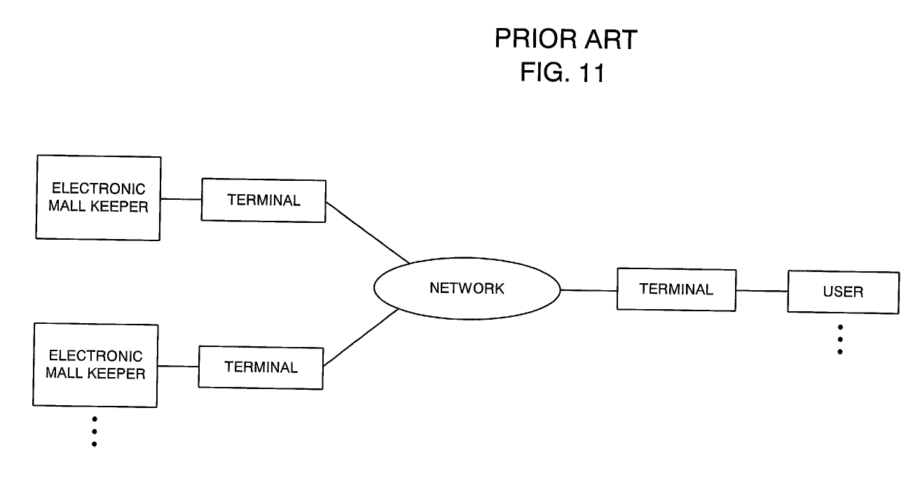

FIG. 12 is a block diagram explaining the operation of the merchandise transaction method on on-line shopping shown in FIG. 10.

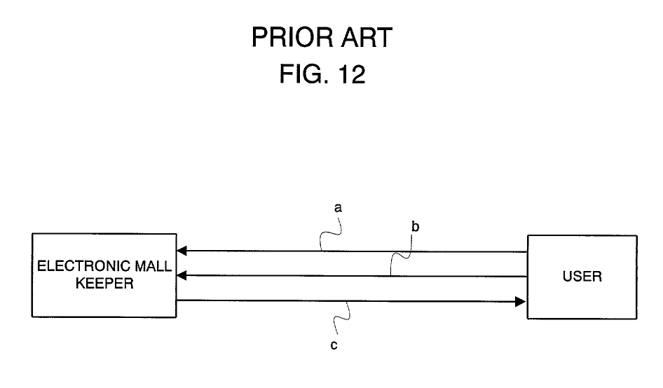

### DESCRIPTION OF THE EMBODIMENTS

Next, the present invention will be described below by referring to the attached drawings.

First Embodiment:

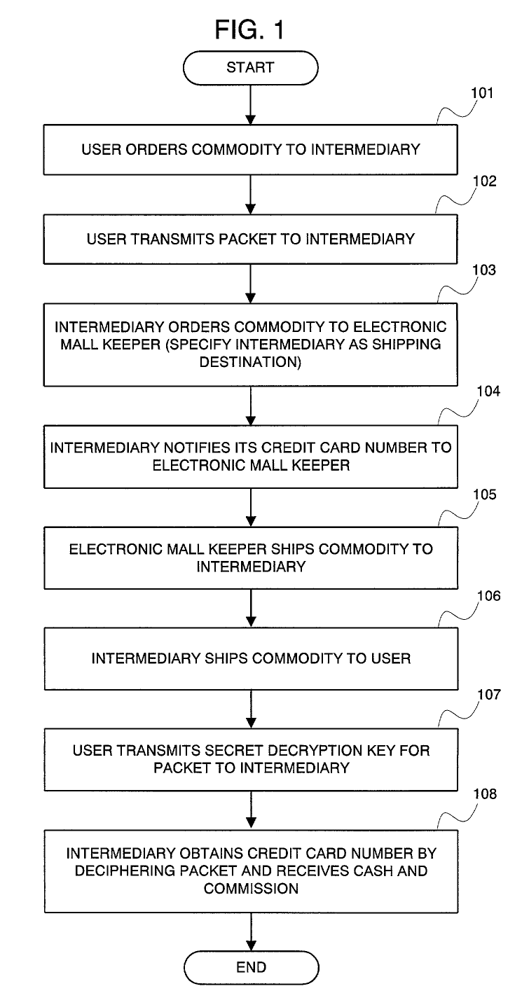

FIG. 1 is a flow chart illustrating the process procedure of a merchandise transaction method on on-line shopping, according to the first embodiment of the present invention.

Referring to FIG. 1, the merchandise transaction method on on-line shopping, according to the present invention, includes a user merchandise ordering step 101, a packet transmission step 10, an intermediary merchandise ordering step 103, a credit card number notification step 104, an electronic mall merchandise shipping step 105, an intermediary merchandise shipping step 106, a secret decryption key transmission step 107, and a cash/commission receiving step 108.

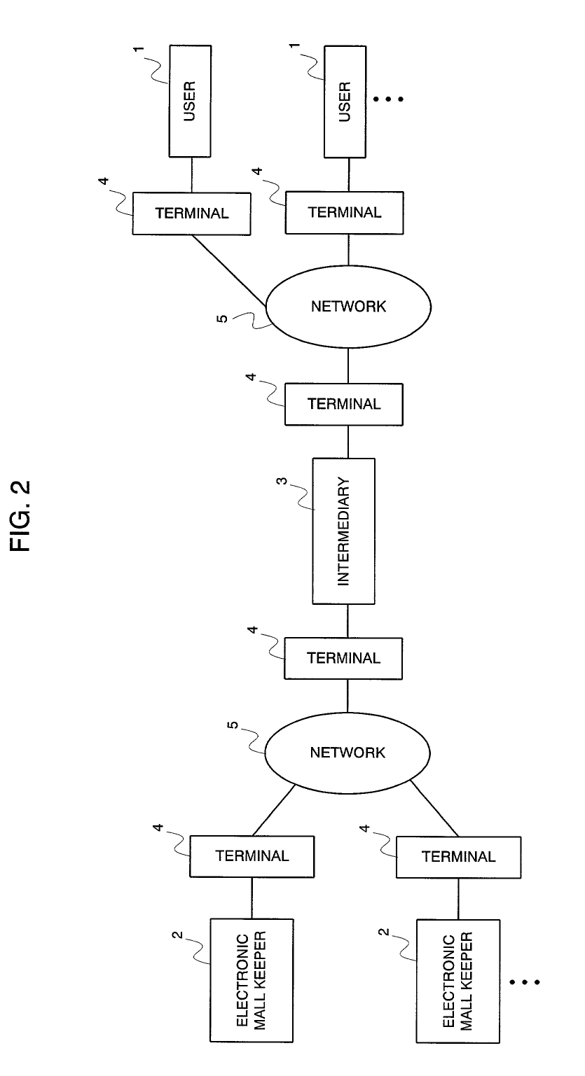

FIG. 2 is a block diagram illustrating the configuration of an on-line shopping system to realize the merchandise transaction method on on-line shopping, according to the present invention. This on-line shopping system consists of plural users 1, plural electronic mall keepers 2, an intermediary 3, and terminals (information processing terminals) 4 each used by the users 1, the electronic mall keepers 2, and the intermediary 3, and networks 5 (for convenience of explanation of the transaction procedure, FIG. 2 shows two terminals 5).

In the present embodiment shown in FIG. 2, an intermediary 3 is a third party mediating a transaction between a user 1 and plural electronic mall keepers 2. That is, the user 1 deals with the intermediary 3, without dealing with the electronic mall keeper 2. Similarly, the electronic mall keeper 2 deals with the intermediary 3, without dealing with the user 1.

Thus, the user 1 is protected from a dishonest electronic mall keeper 2 by having dealings through the intermediary 3, without directly dealing with an unspecified number of electronic mall keepers 2. On the other hand, by acquiring a key (secret decryption key) to access the number of a credit card number, in exchange of an arrived item, the intermediary 3 is protected from an illegal act of the user 1 (that is, the electronic mall keeper 2 is protected from an illegal act of the user 1).

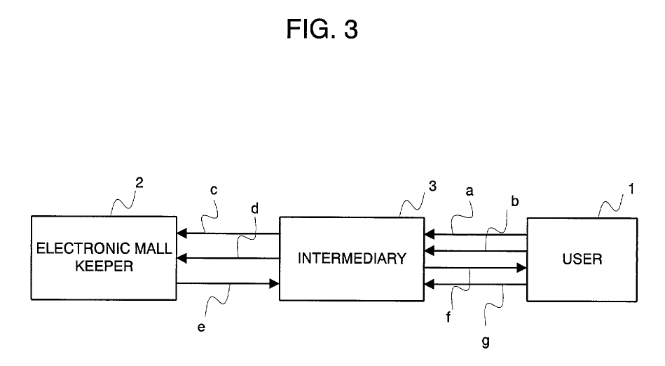

FIG. 3 is a block diagram explaining the process of the merchandise transaction method on on-line shopping, according to the present invention.

Next, the operation of the merchandise transaction method on on-line shopping with the above-mentioned configuration, according to the present embodiment, will be explained below in detail.

When the user 1 purchases an item from the electronic mall keeper 2 via the intermediary 3, the terminal 4 and the network 5 are used to conduct the operation (transaction) in accordance with the following procedures (a to g). Symbols (a to g) in FIG. 3 correspond to the following descriptions (a to g), respectively.

(a) The user 1 orders an item (or commodity) by transmitting information about a desired electronic mall keeper and information about an item (or commodity) to be purchased (step 101 in FIG. 1).

(b) The user 1 transmits a packet regarding a merchandise order in the step 101 to the intermediary 3 (step 102). The packet is one obtained by enciphering a credit card number. This cipher is deciphered with a sequence of plural characters called a secret decryption key (or a key uniquely defined by the user 1). It is assumed that the system (software) that creates the packet and transmits it to the intermediary 3 is previously distributed to respective users 1. What is important is that the intermediary 3 cannot acquire the credit card number without a secret decryption key.

(c) The intermediary 3 orders an item (desired by the user 1) to the electronic mall keeper 2 (to which the user 1 desires transaction), based on information transmitted from the user 1 (step 103). At this time, the intermediary 3 specifies (the intermediary 3) itself as a merchandise shipping destination.

(d) Moreover, the intermediary 3 notifies the electronic mall keeper 2 of the credit card number of the intermediary 3, using information transfer means such as the terminal 4 or the FAX machine (step 104). Since the credit card number known to the electronic mall keeper 2 is the credit card number of the intermediary 3, not the credit card number of the user 1, the user 1 can be protected from the illegal act (that is, from the act where the electronic mall keeper 2 may use the credit card number of the user 1).

(e) The electronic mall keeper 2 dispatches the item to the intermediary 3 by means of transportation means (step 105).

(f) The intermediary 3 receives the item and then dispatches it to the user 1 by means of transportation means (step 106).

(g) The user 1 transmits a secret decryption key to decipher the cipher of the packet (transmitted in the step 102), in exchange of the receiving of the item (dispatched in the step 106) (step 107). Thus, the intermediary 3 can obtain the secret decryption key.

(h) The intermediary 3 decipher the packet with the secret decryption key to obtain the credit card number of the user 1 and receives the cash and commission of the item with the credit card number (step 108).

Second Embodiment:

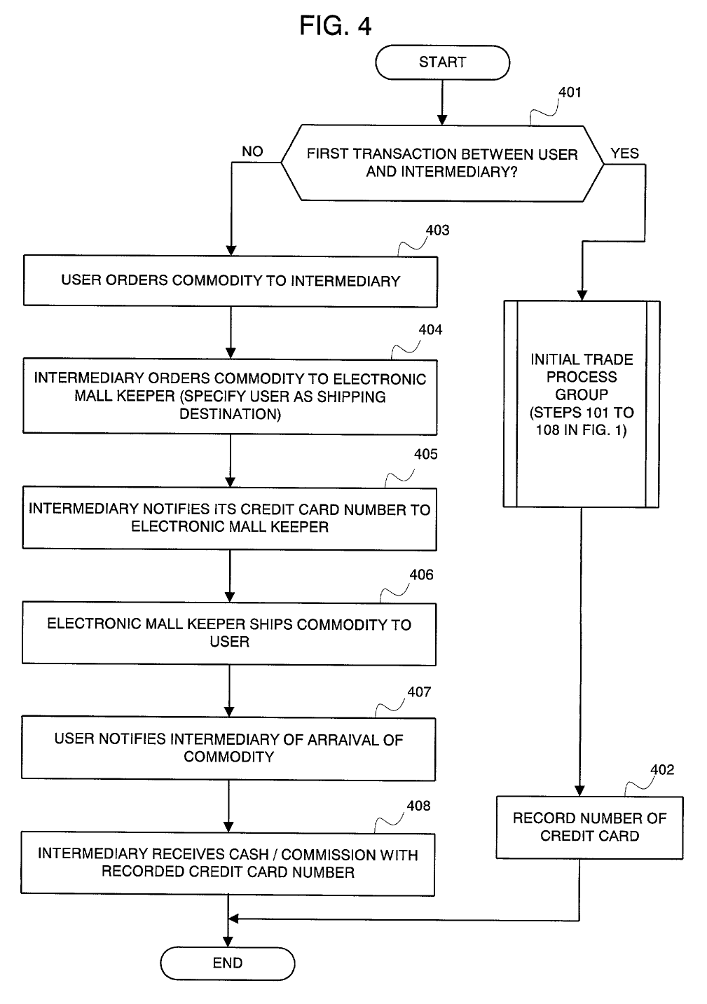

FIG. 4 is a flow chart illustrating the process procedure of the merchandise transaction method on on-line shopping, according to the second embodiment of the present invention.

Referring to FIG. 4, the merchandise transaction method on on-line shopping, according to the present invention, includes a transaction-count decision step 401, an initial transaction process group (including a user merchandise ordering step 101, a packet transmission step 102, an intermediary merchandise ordering step 103, a credit-card number notification step 104, an electronic mall keeper merchandise shipping step 105, an intermediary merchandise shipping step 106, a secret decryption key transmission step 107, and a cash/commission receiving step 108), a credit card number recording step 402, a second or later transaction user merchandise ordering step 403, a second or later transaction intermediary merchandise ordering step 404, a second or later transaction credit card number notification step 405, a second or later transaction electronic mall keeper merchandise shipping step 406, a merchandise arrival notification step 407, and a second or later cash/commission receiving step 408. The steps 101 to 108 are identical to the steps 101 to 108 in the first embodiment shown in FIG. 1, respectively.

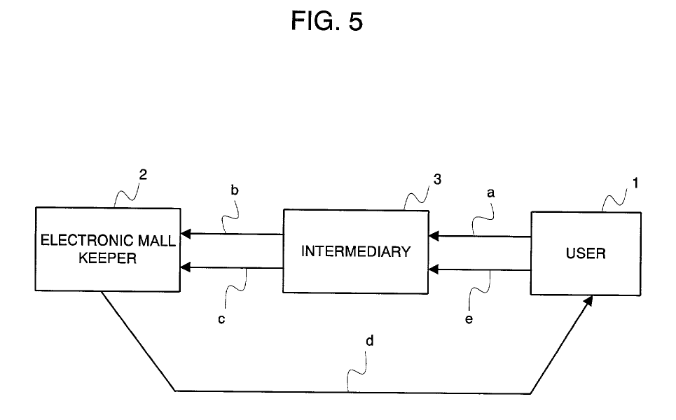

FIG. 5 is a block diagram illustrating the process of the merchandise transaction method on on-line shopping, according to the present embodiment (or a diagram explaining the process of the second or later transaction between a user 1 and the intermediary 3).

FIG. 2 is a block diagram illustrating the configuration of an on-line shopping system to realize the merchandise transaction method on on-line shopping, according to the present embodiment.

FIG. 3 is a block diagram explaining the process of a merchandise transaction method on on-line shopping according to the present embodiment (or a block diagram explaining the process in the first transaction between a user 1 and the intermediary 3).

Next, the operation of the merchandise transaction method on on-line shopping with the above-mentioned configuration, according to the present embodiment, will be described below in detail.

When a user 1 purchases an item from the electronic mall keeper 2 via the intermediary 3, it is checked whether or not the transaction between the user 1 and the intermediary 3 is for the first time (whether or not the transaction is for the first time or the second time or later) (step 401 in FIG. 4).

When it is decided that the transaction between the user 1 and the intermediary 3 is for the first time in the step 401, the same series of steps as those in the first embodiment (the first transaction process group in FIG. 4. Refer to the steps 101 to 108 in FIG. 1 and to FIG. 3) are executed. Then, the next process is implemented.

For example, the intermediary 3 records the corresponding information inside itself after the first transaction with the user 1 (step 402). Thus, the credit card number of the user 1 can be uniquely identified to the user 1 to accept the second or later transaction with the user 1.

On the other hand, in the step 401, when it is decided that the transaction between the user 1 and the intermediary 3 is not the first transaction (or when the user 1 uses the intermediary 3 at the second time or later), the operation (transaction) is carried out in accordance with the procedure (a to f), using the terminal 4 and the network 5. The symbols (a to e) shown in FIG. 5 are identical to the following descriptions (a to e), respectively.

That is, it is regarded that the confidence between the user 1 and the intermediary 3 has been established by completely ending the first transaction between the user 1 and the intermediary 3. In the second transaction or later, the merchandise ordering process can be simplified as shown below (refer to FIG. 5 in contrast with FIG. 3).

(a) The user 1 orders items by transmitting information about a desired electronic mall keeper 2 and information about items to be purchased to the intermediary 3 (step 403).

(b) The intermediary 3 orders the items (to be purchased by the user 1) to the electronic mall keeper 2 (specified by the user 1), based on information transmitted from the user 1 (step 404). The intermediary 3 specifies the user 1 as the destination to which items are dispatched.

(c) Moreover, the intermediary 3 notifies the electronic mall keeper 2 of the credit card number of the intermediary 3, using information transfer means such as the terminal 4 or FAX machine (step 405).

(d) The electronic mall keeper 2 ships the items to the user 1 using transportation means (step 406).

(e) The user 1 which has received the items notifies the intermediary 3 of the arrival of them (step 407).

(f) The intermediary 3 receives the cash and commission for the items in accordance with the credit card number which recorded at the first transaction with the user 1 (step 408)

Third Embodiment:

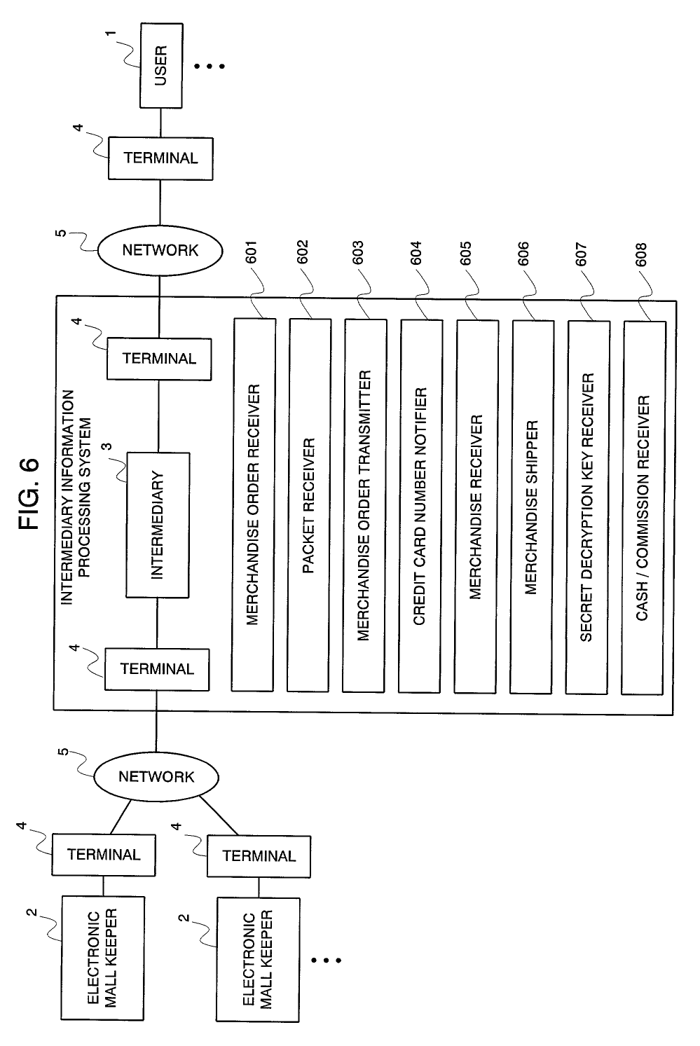

FIG. 6 is a block diagram illustrating the configuration of the intermediary information processing system according to the third embodiment of the present invention.

Referring to FIG. 6, the intermediary information processing system includes, as an information processing system realizing the function of the intermediary 3 in FIG. 2, a merchandise order receiver 601, a packet receiver 602, a merchandise order transmitter 603, a credit card number notifier 604, a merchandise receiver 605, a merchandise shipper 606, a secret decryption key receiver 607, and a cash/commission receiver 608.

The merchandise order receiver 601 receives from the user 1 a merchandise order including information about a desired electronic mall keeper 2 and information about an item to be purchased.

The packet receiver 602 receives a packet transmitted from the user 1 in the merchandise order by the merchandise order receiver 601.

The merchandise order transmitter 603 orders an item to the electronic mall keeper 2 by specifying the intermediary 3 as a merchandise shipping destination, based on the information transmitted from the user 1 (or information received by the merchandise order receiver 601).

In order to pay money for the merchandise order by the merchandise order transmitter 603, the credit card number notifier 604 notifies the electronic mall keeper 2 of the credit card number of the intermediary 3.

The merchandise receiver 605 receives the item dispatched from the electronic mall keeper 2.

The merchandise shipper 606 ships the item received by the merchandise receiver 605 to the user 1.

The secret decryption key receiver 607 receives a secret decryption key sent from the user 1, in exchange of the receiving of the item.

The cash/commission receiver 608 acquires the credit card number by deciphering the cipher of the packet using the secret decryption key received by the secret decryption key receiver 607 and then receives the cash and commission for the item with the credit card number.

The intermediary information processing system with the above-mentioned configuration according to the present embodiment performs the operation of realizing the process shown in FIG. 1. The content of the operation (process) is identical to that of the merchandise transaction method on on-line shopping, in the first embodiment.

Fourth Embodiment:

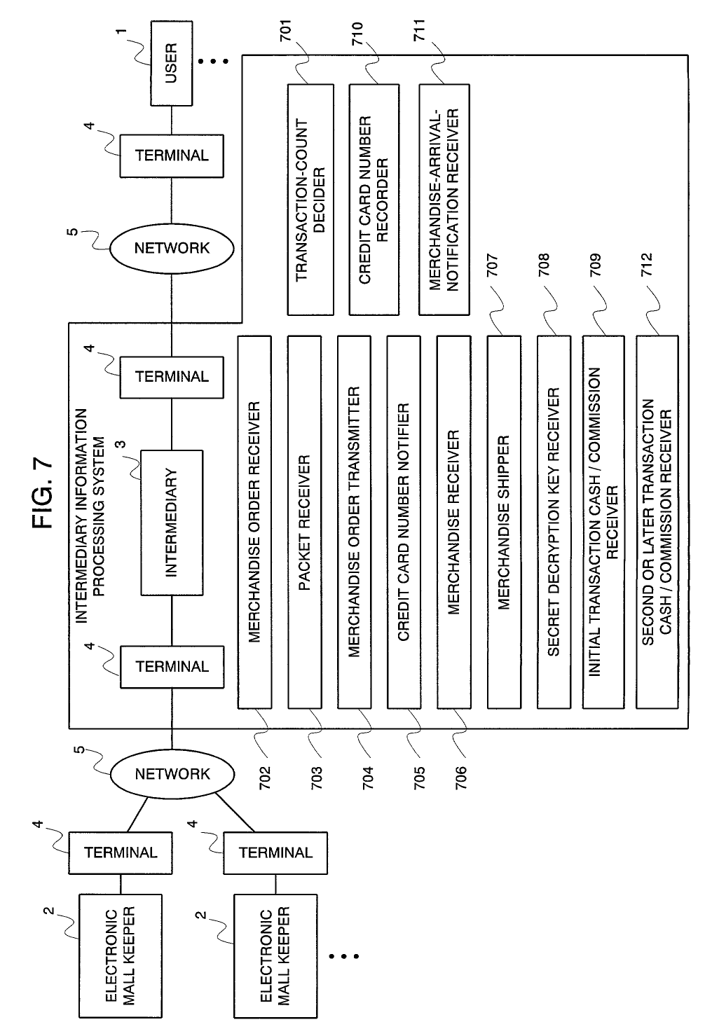

FIG. 7 is a block diagram illustrating the configuration of the intermediary information processing system according to the fourth embodiment.

Referring to FIG. 7, the intermediary information processing system according to the present embodiment acts as an information processing system realizing the function of the intermediary 3 of FIG. 2. The intermediary information processing system includes a transaction-count decider 701, a merchandise order receiver 702, a packet receiver 703, a merchandise order transmitter 704, a credit card number notifier 705, a merchandise receiver 706, a merchandise shipper 707, a secret decryption key receiver 708, an initial cash/commission receiver 709, a credit card number recorder 710, a merchandise arrival notification receiver 711, and a second or later transaction cash/commission receiver 712.

The transaction-count decider 701 decides whether or not the user 1, which wants to purchase an item, is trying the first transaction.

The merchandise order receiver 702 receives from the user 1 a merchandise order including information about a desired electronic mall keeper 2 and information about an item to be purchased.

When the transaction-count decider 701 decides that the transaction to the user 1 (trying to purchase an item) is for the first time, the packet receiver 703 receives a packet transmitted from the user 1 in the merchandise order by the merchandise order receiver 702.

The merchandise order transmitter 704 orders the item to the electronic mall keeper 2 based on the information transmitted from the user 1 (information received by the merchandise order receiver 702). At this time, when the transaction-count decider 701 decides that the transaction to the user 1 is for the first time, the merchandise order transmitter 704 specifies the intermediary 3 as a merchandise shipping destination. When the transaction-count decider 701 decides that the transaction to the user 1 is not for the first time (or is for the second time or later), the merchandise order transmitter 704 specifies the user 1 as a merchandise shipping destination.

In order to pay the money for the merchandise order of the merchandise order transmitter 704, the credit card number notifier 705 notifies the electronic mall keeper 2 of the credit card number of the intermediary 3.

The merchandise receiver 706 receives the item shipped from the electronic mall keeper 2 via the intermediary 3 acting as a shipping destination.

The merchandise shipper 707 dispatches the item received by the merchandise receiver 706 to the user 1.

When the transaction-count decider 701 decides that the transaction to the user 1 is for the first time, the secret decryption key receiver 708 receives the secret decryption key transmitted from the user 1, in exchange of the receiving of the item.

The initial transaction cash/commission receiver 709 acquires the credit card number by deciphering the cipher of the packet with the secret decryption key received by the secret decryption key receiver 708. Thus the initial transaction cash/commission receiver 709 receives the cash and commission of the item with the credit card number.

When the transaction-count decider 701 decides that the transaction to the user 1 is for the first time, the credit card number recorder 710 records the corresponding information. For the purpose of the second or later transaction to the user 1, the information uniquely identifies the user 1 with the credit card number of the user 1 acquired by the initial transaction cash/commission receiver 709.

When the transaction-count decider 701 decides that the transaction to the user 1 is not for the first time, the merchandise arrival notification receiver 711 receives notification about the arrival of the item dispatched from the electronic mall keeper 2 to the user 1.

When the transaction-count decider 701 decides that the transaction to the user 1 is not for the first time, the second or later transaction cash/commission receiver 712 receives the cash and commission of the item with the credit card number of the user 1 recorded by the credit card number recorder 710.

The intermediary information processing system with the above-mentioned configuration according to the present embodiment implements the operation of realizing the process shown in FIG. 4. The content of the operation (transaction) is similar to that in the merchandise transaction method on on-line shopping, according to the second embodiment.

Fifth Embodiment:

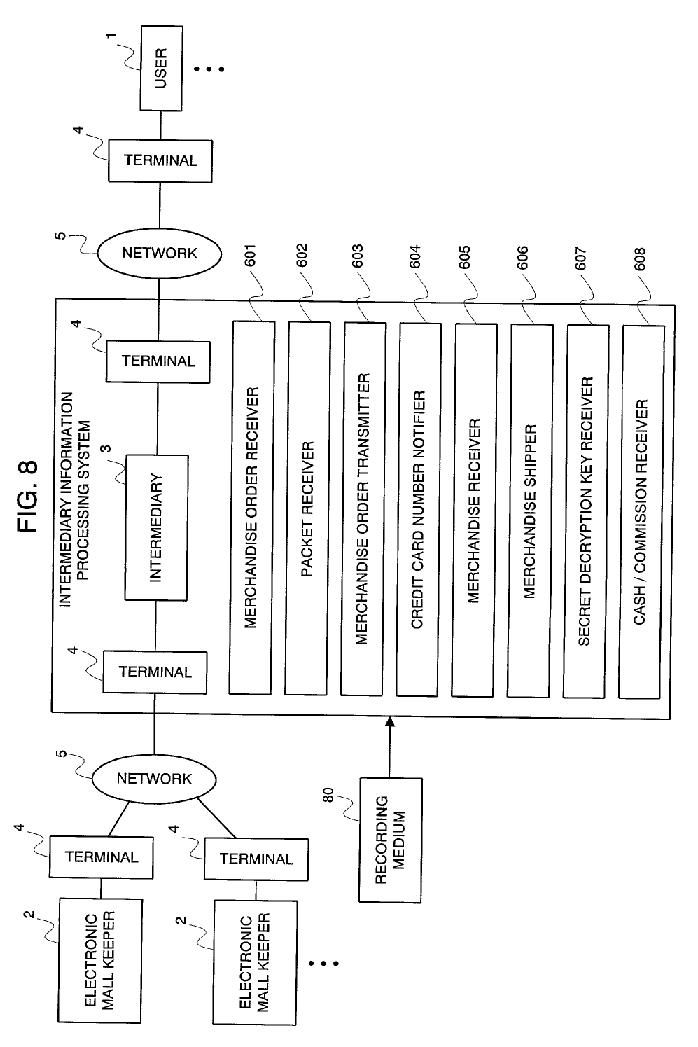

FIG. 8 is a block diagram illustrating the configuration of the intermediary information processing system according to the fifth embodiment of the present invention.

Referring to FIG. 8, the intermediary information processing system in the fifth embodiment differs from the intermediary information processing system in the third embodiment in that the recording medium 80 recording the intermediary information processing program is prepared. The recording medium 80 may be a magnetic disk, a semiconductor memory, or others.

The intermediary information processing program is read from the recording medium 80 into the intermediary information processing system (including a merchandise order receiver 601, a packet receiver 602, a merchandise order transmitter 603, a credit card number notifier 604, a merchandise receiver 605, a merchandise shipper 606, a secret decryption key receiver 607, and a cash/commission receiver 608). The operation of the intermediary information processing system is controlled as the merchandise order receiver 601, the packet receiver 602, the merchandise order transmitter 603, the credit card number notifier 604, the merchandise receiver 605, the merchandise shipper 606, the secret decryption key receiver 607, and the cash/commission receiver 608. The respective operations of the merchandise order receiver 601, the packet receiver 602, the merchandise order transmitter 603, the credit card number notifier 604, the merchandise receiver 605, the merchandise shipper 606, the secret decryption key receiver 607, and the cash/commission receiver 608 under the intermediary information process program are totally identical to the respective operations of the corresponding elements in the third embodiment, respectively. Hence, the duplicate explanation will be omitted here.

Sixth Embodiment:

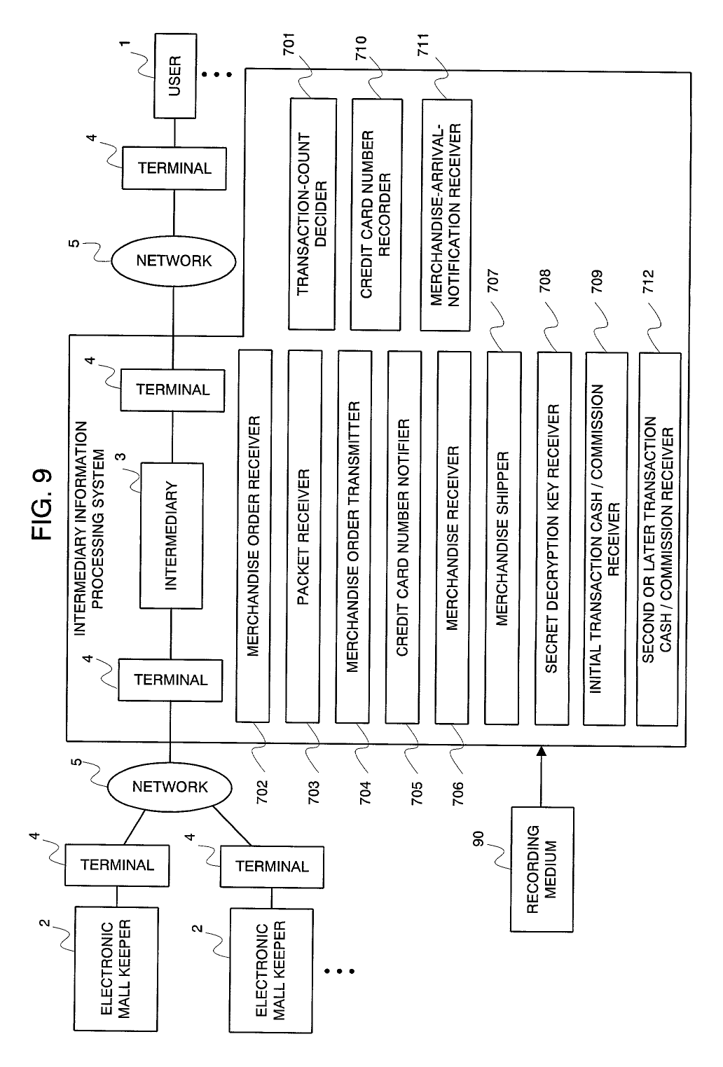

FIG. 9 is a block diagram illustrating the configuration of the intermediary information processing system according to the sixth embodiment of the present invention.

Referring to FIG. 9, the intermediary information processing system according to the sixth embodiment differs from the intermediary information processing system of the fourth embodiment in that the recording medium 90 recording the intermediary information process program is prepared. The recording medium 90 may be a magnetic disk, a semiconductor memory, or others.

The intermediary information processing program on the recording medium 90 is read into the intermediary information processing system (including a transaction-count decider 701, a merchandise order receiver 702, a packet receiver 703, a merchandise order transmitter 704, a credit card number notifier 705, a merchandise receiver 706, a merchandise shipper 707, a secret decryption key receiver 708, an initial transaction cash/commission receiver 709, a credit card number recorder 710, a merchandise arrival notification receiver 711, and a second or later transaction cash/commission receiver 712). The operation of the intermediary information processing system is controlled as the transaction-count decider 701, the merchandise order receiver 702, the packet receiver 703, the merchandise order transmitter 704, the credit card number notifier 705, the merchandise receiver 706, the merchandise shipper 707, the secret decryption key receiver 708, the initial transaction cash/commission receiver 709, the credit card number recorder 710, the merchandise arrival notification receiver 711, and the second or later transaction cash/commission receiver 712. The respective operations of the transaction-count decider 701, the merchandise order receiver 702, the packet receiver 703, the merchandise order transmitter 704, the credit card number notifier 705, the merchandise receiver 706, the merchandise shipper 707, the secret decryption key receiver 708, the initial transaction cash/commission receiver 709, the credit card number recorder 710, the merchandise arrival notification receiver 711, and the second or later transaction cash/commission receiver 712 under control of the intermediary information process program are totally identical to the operations of the corresponding elements in the fourth embodiment, respectively. Hence, the duplicate explanation will be omitted here.

The present invention described above has the following advantages.

The benefits of users are as follows:

(a) Since it is unnecessary to transmit a credit card number to each of electronic mall keepers for transaction, it can be prevented that a dishonest electronic mall keeper knows the credit card number. So long as the initial transaction between a user and an electronic mall keeper is not completed, it does not occur that the intermediary knows the user's credit card number.

(b) Since there is no step of shipping an item without processing a credit card number (or since the transmission of a credit card number packeted in the second time or later transaction does not appear in the transaction procedure), the risk that the credit card number is stolen through tapping so that the safety of the user can be guaranteed.

(c) Since the transaction is carried out via an intermediary without directly bargaining with an indefinite number of electronic mall keepers, what the user has to do is to notice only the credibility of an intermediary.

Moreover, the benefit of the intermediary is that a dishonest transaction of a user can be effectively prevented because a secret decryption key is acquired in exchange of goods.

Moreover, the benefit of the existing electronic mall keepers is that the method of the present invention can be effectively applied without changing the existing on-line shopping method. This benefit comes from the feature that, in the method of the present invention, the intermediary performs transactions in behalf of users, in a manner similar to the user's conventional procedure (or in the procedure of ordering items via an information processing terminal and then paying the money to an electronic mall keeper with the credit card number of the intermediary). That is, even in the method of the present invention, the procedure of the electronic mall keeper is not substantially different from that to the user in the conventional on-line shopping method.

In the second or later transaction between a user and an electronic mall keeper, it is assumed that the credibility between them has been established. Thus, the merchandise ordering process can be simplified (or the ordering process in the second or later transaction based on authentication of a secret decryption key in the initial transaction can be shortened) (refer to the invention defined in claims 2 and 4). In this case, when a user purchases items at the second time or later, the intermediary does not require packets so that dealings can be conducted more quickly.

The entire disclosure of Japanese Patent Application No. 2000-029876 filed on Feb. 8, 2000 including specification, claims, drawing and summary are incorporated herein by reference in its entirety.

What is claimed is:

1. A merchandise transaction method on on-line shopping in an on-line shopping system, comprising:
a first step in which an intermediary receives information about an electronic mall keeper to which a user desires transaction, information about commodities to be purchased by said user, and a packet and executes an order and payment of commodities to an electronic mall keeper in behalf of said user; and
a second step in which said intermediary receives a secret decryption key for said packet transmitted from said user in exchange of said commodities and then obtains a credit card number of said user by deciphering the packet cipher.

2. A merchandise transaction method on on-line shopping in an on-line shopping system, comprising:
at a first transaction between a user which desires to purchase commodities and an intermediary, a first step in which an intermediary receives information about an electronic mall keeper to which said user desires transaction, information about commodities to be purchased by said user, and a packet and executes an order and payment of commodities to an electronic mall keeper in behalf of said user;
a second step in which said intermediary receives a secret decryption key for said packet transmitted from said user in exchange of said commodities and then obtains a credit card number of said user by deciphering the packet cipher;
a third step in which said intermediary records a credit card number of said user acquired through decryption of said packet;
at the second or later transaction between said user which desires to purchase commodities and said intermediary, a fourth step in which said intermediary receives information about an electronic mall keeper to which said user desires transaction and information about commodities to be purchased by said user and then executes an order and payment of said commodities to an electronic mall keeper in behalf of said user; and
a fifth step in which said intermediary acquires a credit card number of said user based on the record in said third step.

3. A merchandise transaction method in an on-line shopping system, comprising:
a user merchandise ordering step in which a user orders commodities by transmitting information about a desired electronic mall keeper and information about commodities to be purchased to an intermediary;
a packet transmission step in which said user transmits a packet regarding the merchandise order in the previous step to said intermediary;
an intermediary merchandise ordering step in which said intermediary orders commodities by specifying itself as a merchandise shipping destination to said electronic mall keeper, based on the information received in the previous step;
a credit card number notification step in which said intermediary notifies said electronic mall keeper of a credit card number of said intermediary;
an electronic mall keeper merchandise shipping step in which said electronic mall keeper ships said commodities to said intermediary;
an intermediary merchandise shipping step in which said intermediary ships said commodities to said user;
a secret decryption key transmission step in which said user transmits a secret decryption key for said packet to said intermediary, in exchange of the commodities received in the previous step; and
a cash and commission receiving step in which said intermediary acquires a credit card number by deciphering the previously received packet cipher with the secret decryption key acquired in the precious step and then receives a cash and commission of the commodities with the credit card number.

4. A merchandise transaction method on on-line shopping in an on-line shopping system, comprising:
a transaction-count decision step of deciding whether or not a transaction between a user which wants to purchase a commodity and an intermediary is for the first time;
a user merchandise ordering step in which said user orders the commodity by transmitting information about an electronic mall keeper desired by said user and information about a commodity to be purchased to said intermediary when it is decided that the transaction between said user and said intermediary is for the first time in the previous step;
an intermediary merchandise ordering step in which said intermediary orders the commodity by specifying itself as a merchandise shipping destination to an electronic mall keeper, based on the sets of information received in the previous step;
a credit card number notification step in which said intermediary notifies the credit card number of said intermediary to said electronic mall keeper at the first transaction between the user and the intermediary;
an electronic mall merchandise shipping step in which said electronic mall keeper ships said commodity to said intermediary at the first step between said user and said intermediary;
an intermediary merchandise shipping step in which said intermediary ships said commodity to said user at the first step between said user and said intermediary;
a secret decryption key transmission step in which said user transmits said secret decryption key for the packet to said intermediary, in exchange of the commodity received in the previous step;
a cash and commission receiving step in which said intermediary acquires the credit card number by deciphering the cipher of said packet received in the previous step with the secret decryption key acquired in the previous step and then receives a cash and commission for said commodity with said credit card number;
a credit card number recording step in which said intermediary records corresponding information for the purpose of the second or later transaction to said user, said corresponding information being used to uniquely identify said user with the credit card number of said user obtained in the previous step;
a second or later transaction user merchandise ordering step in which said user orders the commodity by transmitting information about a desired electronic mall keeper and information about a desired commodity to said intermediary when it is decided that a transaction between the user and the intermediary is the second time or later in the previous step;
a second or later transaction intermediary merchandise ordering step in which said intermediary orders said commodity by specifying said user as a merchandise shipping destination to said electronic mall keeper, based on the information received in the previous step;
a second or later transaction credit card number notification step in which said intermediary notifies the credit card number of said intermediary to said electronic mall keeper at the second or later transaction between the user and the intermediary;
a second and later transaction electronic mall keeper merchandise shipping step in which said electronic mall keeper ships said commodity to said user at the second or later transaction between said user and said intermediary;
a merchandize arrival notification step in which said user, which has received said commodity in the previous step, notifies said intermediary of arrival of said commodity; and
a second or later transaction cash and commission receiving step in which said intermediary receives a cash and commission of said commodity with the credit card number of said user recorded in the previous step at the second or later transaction between said user and said intermediary.

5. An intermediary information processing system which intermediates between a user and an electronic mall keeper in an on-line shopping system, comprising
a merchandise order receiver for receiving an order of a commodity from a user, said commodity order including information about a desired electronic mall keeper and information about a commodity to be purchased;
a packet receiver for receiving a packet transmitted by said user in the merchandise order by said merchandise order receiver;
a merchandise order transmitter for ordering said commodity by specifying said intermediary as a merchandise shipping destination to said electronic mall keeper, based on information received by said merchandise order receiver;
a credit card number notifier for notifying said electronic mall keeper of the credit card number of said intermediary to pay for a merchandise order by said merchandise order transmitter;
a merchandise receiver for receiving the commodity shipped by said electronic mall keeper;
a merchandise shipper for shipping the commodity received by said merchandise receiver to said user;
a secret decryption key receiver for receiving a secret decryption key transmitted from said user, in exchange of reception of the commodity; and
a cash/commission receiver for acquiring a credit card number by deciphering the packet cipher with the secret decryption key received by said secret decryption key receiver and then receiving a cash and commission of the commodity with the credit card number.

6. An intermediary information processing system which intermediates between a user and an electronic mall keeper in an on-line shopping system, comprising:
a transaction-count decider for deciding whether or not a transaction to a user which wants to purchase a commodity is for the first time;
a merchandise order receiver for receiving an order of a commodity from a user, said commodity order including information about a desired electronic mall keeper and information about a commodity to be purchased;
a packet receiver for receiving a packet transmitted by said user in the merchandise order by said merchandise order receiver when said transaction-count decider decides that the transaction to said user is for the first time;
a merchandise order transmitter for ordering said commodity to said electronic mall keeper, based on information received by said merchandise order receiver, by specifying said intermediary as a merchandise shipping destination when said transaction-count decider decides that the transaction to said user is for the first time or by specifying said user as a merchandise shipping destination when said transaction-count decider decides that the transaction to said user is not for the first time;
a credit card number notifier for notifying said electronic mall keeper of the credit card number of said intermediary to pay for a merchandise order by said merchandise order transmitter;
a merchandise receiver for receiving the commodity shipped by said electronic mall keeper, with said intermediary as a merchandise shipping destination;
a merchandize shipper for shipping the commodity received by said merchandise receiver to said user;
a secret decryption key receiver for receiving a secret decryption key transmitted from said user, in exchange of reception of the commodity when said transaction-count decider decides that the transaction to said user is for the first time;
an initial cash/commission receiver for acquiring a credit card number by deciphering the packet cipher with the secret decryption key received by said secret decryption key receiver and then receiving a cash and commission of the commodity with the credit card number;
a credit card number recorder for recording corresponding information to pay for the second or later transaction to said user when said transaction-count decider decides that the transaction to said user is for the first time, said corresponding information being used to uniquely identify said user with the credit card number of said user acquired by said initial cash/commission receiver;
a merchandise arrival notification receiver for receiving notification of arrival of the commodity dispatched from said electronic mall keeper to said user when said transaction count decider decides that the transaction to said user is not for the first time; and
a second or later transaction cash/commission receiver for receiving a cash and commission for the commodity with the credit card number of said user recorded by said credit card number recorder when said transaction count decider decides that the transaction to said user is not for the first time.

7. A recording medium on which a program is recorded, wherein said program realizes an intermediary information processing system which intermediates between a user and an electronic mall keeper in an on-line shopping system as functions including:
a merchandise order receiver for receiving an order of a commodity from a user, said commodity order including information about a desired electronic mall keeper and information about a commodity to be purchased;
a packet receiver for receiving a packet transmitted by said user in the commodity order by said merchandize order receiver;
a merchandise order transmitter for ordering said commodity by specifying said intermediary as a merchandise shipping destination to said electronic mall keeper, based on information received by said merchandise order receiver;
a credit card number notifier for notifying said electronic mall keeper of the credit card number of said intermediary to pay for the commodity order by said merchandise order transmitter;
a merchandise receiver for receiving the commodity shipped by said electronic mall keeper;
a merchandise shipper for shipping the commodity received by said merchandise receiver to said user which ordered said commodity;
a secret decryption key receiver for receiving said secret decryption key transmitted from said user, in exchange of reception of the commodity; and
a cash/commission receiver for acquiring a credit card number by deciphering the packet cipher with the secret decryption key received by said secret decryption key receiver and then receiving a cash and commission for the commodity with the credit card number.

8. A recording medium on which a program is recorded, wherein said program realizes an intermediary information processing system which intermediates between a user and an electronic mall keeper in an on-line shopping system as functions including:
a transaction-count decider for deciding whether or not a transaction to a user which wants to purchase a commodity is for the first time;
a merchandise order receiver for receiving an order of a commodity from a user, said commodity order including information about a desired electronic mall keeper and information about a commodity to be purchased;
a packet receiver for receiving a packet transmitted by said user in the merchandise order by said merchandize order receiver when said transaction-count decider decides that the transaction to said user is for the first time;
a merchandize order transmitter for ordering said commodity to said electronic mall keeper, based on information received by said merchandise order receiver, by specifying said intermediary as a merchandise shipping destination when said transaction-count decider decides that the transaction to said user is for the first time or by specifying said user as a merchandise shipping destination when said transaction-count decider decides that the transaction to said user is not for the first time;
a credit card number notifier for notifying said electronic mall keeper of the credit card number of said intermediary to pay for a merchandise order by said merchandise order transmitter;
a merchandise receiver for receiving the commodity shipped by said electronic mall keeper, with said intermediary as a merchandise shipping destination;
a merchandize shipper for shipping the commodity received by said merchandise receiver to said user which ordered said commodity;
a secret decryption key receiver for receiving said secret decryption key transmitted from said user, in exchange of reception of the commodity when said transaction-count decider decides that the transaction to said user is for the first time;
an initial cash/commission receiver for acquiring a credit card number by deciphering the packet cipher with the secret decryption key received by said secret decryption key receiver and then receiving a cash and commission of the commodity with the credit card number;
a credit card number recorder for recording corresponding information for the purpose of the second or later transaction when said transaction-count decider decides that the transaction to said user is for the first time, said corresponding information being used to uniquely identify said user with the credit card number of said user acquired by said initial cash/commission receiver;
a merchandise arrival notification receiver for receiving notification of arrival of the commodity dispatched from said electronic mall keeper to said user when said transaction-count decider decides that the transaction to said user is not for the first time; and
a second or later transaction cash/commission receiver for receiving a cash and commission for the commodity with the credit card number of said user recorded by said credit card number recorder when said transaction-count decider decides that the transaction to said user is not for the first time.

9. A recording medium on which a control program is stored, wherein said control program controls an information processing system of an intermediary which intermediates between a user and an electronic mall keeper in an on-line shopping system, said control program making said information processing device execute the following steps of:
receiving a merchandise order including information about a desired electronic mall keeper and information about an item to be purchased from a user;
receiving a packet transmitted from said user in said merchandise order;
ordering an item by specifying an intermediary as a merchandise shipping destination to said electronic mall keeper, based on the information about said merchandise order;
notifying said electronic mall keeper of a credit card number of said intermediary to pay for said merchandise order;
receiving a secret decryption key transmitted from said user, in exchange of the ordered item; and
acquiring the credit card number by deciphering the packet cipher with the secret decryption key and then receiving a cash and commission of said item with the credit card number.

10. A recording medium on which a control program is stored, wherein said control program controls an information processing system of an intermediary which intermediates between a user and an electronic mall keeper in an on-line shopping system, said control program making said information processing device execute the following steps of:
deciding whether or not a transaction to a user which wants to purchase an item is for the first time;
receiving a merchandise order from a user, said merchandise order including information about a desired electronic mall keeper and information about an item to be purchased;
receiving a packet transmitted by said user in the merchandise order when it is decided that the transaction to said user is for the first time;
ordering said item to said electronic mall keeper, based on information about said received merchandise order, by specifying said intermediary as a merchandise shipping destination when it is decided that the transaction to said user is for the first time or by specifying said user as a merchandise shipping destination when it is decided that the transaction to said user is not for the first time;
notifying said electronic mall keeper of the credit card number of said intermediary to pay for said merchandise order;
receiving a secret decryption key transmitted from said user, in exchange of reception of the item when it is decided that the transaction to said user is for the first time;
acquiring a credit card number by deciphering the packet cipher with the received secret decryption key and then receiving a cash and commission for the item in the first transaction with the credit card number;
recording corresponding information for the second or later transaction to said user when it is decided that the transaction to said user is for the first time, said corresponding information being used to uniquely identify said user with the credit card number of said user acquired in said first transaction;
receiving notification of arrival of the item dispatched from said electronic mall keeper to said user when it is decided that the transaction to said user is not for the first time; and
receiving a cash and commission for the item with the recorded credit card number of said user when it is decided that the transaction to said user is not for the first time.
